(19) United States
(12) Patent Application Publication
(10) Pub. No.: US 2005/0096224 A1
(43) Pub. Date: May 5, 2005

(54) Method for controlling invertebrate pests and/or fungal diseases which affect potatoes or other crops

(76) Inventor: Tudor Dawkins, Hertfordshire (GB)

Correspondence Address: E I du Pont de Nemours & Company, Legal Patents, Wilmington, DE, 19898, US

(21) Appl. No.: 10/500,261

(22) PCT Filed: Feb. 19, 2003
(86) PCT No.: PCT/US03/04881

Related U.S. Application Data
(60) Provisional application No. 60/359,014, filed on Feb. 20, 2002.

(51) Int. Cl. A01N 63/00; A01N 65/00; A01N 25/26

(52) U.S. Cl. 504/100; 424/93.1

(57) ABSTRACT

A method of protecting crop plants by controlling phytophagous invertebrate pests and/or plant diseases caused by fungal pest is disclosed. The method involves applying a series of doses of an aqueous mixture containing an effective amount of a crop protection agent to the locus of the roots of the crop plants by means of perforated or porous conduit (e.g., tubing or irrigation tape) on or near the surface of the soil. At least one dose of the series is applied in the period from one week prior to planting to two days prior to harvest; and at least two doses of the series are applied at least two days apart during the growing season of the crop or the infestation period of a pest being controlled.

### BACKGROUND OF THE INVENTION

The control of invertebrate pests is extremely important in achieving high crop efficiency. Damage by invertebrate pests to growing and stored agronomic crops can cause significant reduction in productivity and thereby result in increased costs to the consumer.

The potato crop is an important crop in Europe and other parts of the world but production is frequently affected by a significant number of arthropod and nematode pests. Current estimates for the United Kingdom (UK) alone indicate that nematodes cost growers ±50 million in control strategies and lost production on an annual basis (MAFF (1999) Potato Cyst Nematode: A Management Guide, Editor W. Parker, MAFF Publications, pp. 1-33. Hereafter: MAFF, 1999). The nematode pests have also been reported in other potato growing regions of the world from North and South America to mainland Europe and South Africa (Turner, S. J. and Evans, K. 1998, The origins, global distribution and biology of potato cyst nematodes (Globodera rostochiensis (Woll.) and Globodera pallida Stone), in Potato Cyst Nematodes. Biology Distribution and Control. Eds Marks, R. J. and Brodie, B. B. CAB International, pp. 749). Key nematode pests are Globodera pallida, Globodera rostochiensis, Trichodorus species, Paratrichodorus species and Longidorus species.

G. pallida and G. rostochiensis are commonly known as cyst nematodes. It is thought that the pest was introduced from the Andean region of South America into the United Kingdom and subsequent trade of infected tubers (or soil on tubers) resulted in the spread to other regions.

When potatoes are planted the emerging roots produce an exudate that stimulates the eggs from a previous infestation to hatch. The hatched nematodes (all male) are attracted to the root and subsequently feed (causing damage) and invade the root tissues. The feeding process in susceptible varieties of potato causes some of the male nematodes to become female. Mating occurs as the body of the female erupts through the wall of the root. The cysts that are visible on the root are the swollen female body that can contain up to 600 eggs. The leathery cysts fall from the roots and are the mechanism of survival of the pest from crop to crop. Thus the multiplication of the pest can be up to 50-fold from the original infestation. The egg viability declines at 15-30% per annum (depending on species) and growers should use wide rotations to assist in the control process (ideally 1 year in 7) but economic pressures often result in crops being grown 1 year in 3. This practice compounds the problem, allowing infestation to be sustained.

The damage to potatoes is not only evident in terms of significant yield loss but also in terms of effects on produce quality. The nematode pests are particularly pernicious and enduring as the pest may be multiplied significantly on a crop and the residual effects may continue for up to 30 years in the form of eggs which remain viable from crop to crop.

Whilst the development of resistant and tolerant varieties of potatoes, use of rotations and intervention with chemicals has assisted in the maintenance of production, the problem of nematodes that affect potatoes is increasing in countries where potatoes are being grown intensively.

Current chemical control methods rely on the use of soil fumigation that is conducted before the crop is planted and/or granular nematocides that are applied at planting. The fumigant nematocides are used to sterilise the soil when pest burdens are high. However, the fumigants are typically toxic to plants which necessitates their use before the crop is planted. Moreover, soil fumigants are not completely effective, since their efficacy depends upon how effectively the soil can be sealed in order to retain the fumigant. Subsurface application of liquid fumigants for controlling nematodes has been reported (T. J. W. Alphey, Hort. Res. 1981, 21, 169-180). Typically the degree of control is rarely in excess of 80% (MAFF, 1999). The significance of this is that the 20% of pests that survive can still cause damage to potatoes and multiply again on the crop. In order to control the residual population, it is usually necessary to apply a granular nematicide after fumigation, at planting. The two treatments add significant cost to the production of potatoes. Where infestations are low to moderate the use of granular nematocides by soil incorporation at planting is the conventional practice. Granular nematocides, provided they are incorporated correctly, can provide up to 95% control (depending on the species present).

As noted above, a combination of rotation and nematicide use has been successful in keeping infestation at a low level. However, the development of varieties of potato resistant to G. rostochiensis has allowed the selection of G. pallida (for which there is no or poor resistance in current potato varieties) which hatches from the eggs in the soil over a longer period. It is generally accepted that the hatching period for G. rostochiensis is typically 4-6 weeks and the hatching period for G. pallida is typically 6-8 weeks. In addition, the persistence of the nematicide to cover the entire hatching period, whilst generally adequate for G. rostochiensis, is often insufficient to cover the entire hatching period of G. pallida (Whitehead, A. G., Tite, D. J., Fraser, J. E. and Nichols, A. J. F., Differential control of potato cyst nematodes, G. rostochiensis and G. pallida by oxamyl and the yields of resistant and susceptible potatoes in treated and untreated soils, Annals of Applied Biology, 1984, 105, pp 231-244. Hereafter: Whitehead et al 1984). Thus the nematicide has decreased in the soil to levels where effective control is not always possible, resulting in some damage to the potatoes and multiplication of the pest. Surveys conducted in the United Kingdom illustrate that G. pallida is now the dominant species (44% incidence in 1993 and 74% incidence in 1997, MAFF, 1999).

In certain soils (Sands) in the United Kingdom the presence of free-living nematodes from the Trichodorus genera also damage potatoes by direct feeding on roots. However, the main economic damage from these nematodes is caused by the transmission of tobacco rattle virus (TRV) which causes necrotic arcs in tubers rendering them unsaleable (French, N. and Wilson, W. R., Influence of Crop Rotation, Weed control and Nematocides on Spraing in Potatoes, Plant Pathology, 1976, 25, pp167-172). There are also other free-living species in some countries (Meloidgne spp.) which also feed on roots causing significant damage (Harris, P., The Potato Crop. The Scientific Basisfor Improvement. Chapman and Hall, 1978).

Granular nematocides were first developed in the middle of the 1970s when the predominant species was G. rostochiensis. The shift to the predominance of G. pallida requires a re-evaluation of control strategies for this important pest of potatoes.

Other arthropod pests (larvae of the Coleoptera and Lepidoptera families and aphids from the Homoptera family which are also virus vectors) also contribute to significant losses in potatoes in many regions of the world. The inherent solubility and dispersion of nematocides in soil also provides control of certain other soil-dwelling arthropods such as wire worm, Agriotes spp. (a coleopteran larval stage which burrows into the tuber). Nematocides, because of their systemic nature also can control pests such as aphids and other arthropod pests that infest the arial parts of the plants. Other pests of potato for which control is desired include Phthorimaea operculella (potato tuber moth), Leptinotarsa decemlineata (Colorado Beetle), Empoasca fabae (green leafhopper) and Eupterycyba jucunda (potato leafhopper).

Oxamyl, also known as N,N-dimethyl-2-methylcarbamoyloxyimino-2-(methylthio)acetamide (see U.S. Pat. No. 3,530,220 and U.S. Pat. No. 3,658,870), was introduced in the United Kingdom in the middle of the 1970's for the control of many of the pests described above in potatoes. The product has been very effective in controlling G. rostochiensis but, for the reasons indicated above, the efficacy could be improved given the shift towards the dominance of G. pallida. Oxamyl is also effective in controlling chewing and sucking insects (including soil insects) and spider mites. Other carbamate nematocides and organophosphorous nematocides may be used for the same purpose and in a similar manner. Thus, improved methods of control using oxamyl and/or the other nematocides are needed.

The control of plant diseases caused by fungal plant pathogens is also extremely important in achieving high crop efficiency. Plant disease damage to ornamental, vegetable, field, cereal, and fruit crops can cause significant reduction in productivity and thereby result in increased costs to the consumer. Many treatments are commercially available for these purposes, but the need continues for new methods for controlling disease that are more effective, less costly, less toxic, or environmentally safer.

As noted above, the potato is an important crop in the United Kingdom and many other regions of the world. Fungal pathogens of the potato include Phytophthora infestans (the causal agent of potato and tomato late blight) and Altemaria solani (the causal agent of potato early blight). Damage to potato crops from these fungal diseases can be severe, leading to complete defoliation of infected plants.

Suppression of lettuce drop caused by the fungal plant pathogen Sclerotinia minor by subsurface drip irrigation versus furrow irrigation has been attributed to differential moisture and temperature effects (A. A. Bell, L. Liu, B. Reidy, R. M. Davis and K. V. Subbarao, Phytopathology, 1998,88,252-259.

It is known that certain pesticides can be applied to plants using irrigation techniques (e.g., drip irrigation) (see e.g., U.S. Pat. No. 5,696,094, U.S. Pat. No. 5,698,592, U.S. Pat. No. 5,830,919 and U.S. Pat. No. 6,107,314).

### SUMMARY OF THE INVENTION

This invention relates to a method of protecting crop plants by controlling phytophagous invertebrate pests and/or plant diseases caused by fungal pests (i.e. fungal pathogens). The method comprises applying a series of doses of an aqueous mixture containing an effective amount of a crop protection agent to the locus of the roots of the crop plants by means of perforated or porous conduit (e.g., tubing or irrigation tape) on or near the surface of the soil; at least one dose of said series being applied in the period from one week prior to planting to two days prior to harvest; and at least two doses of said series being applied at least two days apart during the growing season of the crop or the infestation period of a pest being controlled. Using the method soil-inhabiting invertebrate pests or fungal diseases caused by soil-inhabiting fungal pathogens may be controlled by applying an effective amount of the aqueous mixture to the soil. In addition, foliar-inhabiting invertebrate pests or fungal diseases caused by foliar-inhabiting fungal pathogens may be controlled by applying an effective amount of the aqueous mixture containing a crop protection agent which is then taken up by the plant from the soil.

### BRIEF DESCRIPTION OF FIGURES

FIG. 1 qualitatively represents a decline curve of oxamyl in the soil after a single application plotted together with infestation curves for two nematode species in untreated soil in the United Kingdom.

FIG. 2 qualitatively represents a series of decline curves of oxamyl in the soil after a series of four applications plotted together with the two infestation curves included in FIG. 1.

FIG. 3 represents a typical field layout of a trickle irrigation system that may be used to apply a crop protection agent in accordance with this invention.

FIG. 4 represents a closed system injection apparatus that may be used for mixing a liquid concentrate of crop protection agent with water prior to application of the agent.

FIG. 5 represents a Venturi apparatus for mixing a liquid concentrate of crop protection agent with water prior to application of the agent.

FIG. 6 relates to Test A and represents the number of G. pallida cysts per gram of root mass for several treatment protocols in soil amended with 24 cysts/pot (estimated to be 10 eggs/g of soil) prior to treatment.

FIG. 7 relates to Test A and represents the number of G. pallida cysts per gram of root mass for several treatment protocols in soil amended with 120 cysts/pot (estimated to be 50 eggs/g of soil) prior to treatment.

### DETAILS OF THE INVENTION

The present invention has been designed to effectively apply existing crop protection agents (e.g. oxamyl) or new crop protection agents using aqueous formulations and a liquid delivery system (e.g., a drip or trickle irrigation system), thereby improving the control of pernicious pests affecting crops (e.g., potatoes). The novel control strategy is based upon two elements:
Serial applications of an aqueous mixture containing an appropriate crop protection agent; and
The use of an application system that applies the aqueous mixture on or below the soil surface.

The temporal distribution of the doses of the crop protection agent (e.g., oxamyl) to the locus of the roots (e.g. the roots of a potato crop) may be controlled in accordance with this invention to provide discrete aliquots of the crop protection agent which match the infestation dynamics of the pest.

The application system may be for example, an irrigation system used by growers to supply water to optimize crop growth and development (e.g. the trickle tape system described below). A suitable apparatus for applying a crop protection agent to the locus of the roots of crop plants in a crop field in accordance with this invention might comprise, for example:
(a) a mixing means of incorporating the crop protection agent into a water supply to provide an aqueous mixture;
(b) a pump for pumping the aqueous mixture from the mixing means;
(c) one or more supply pipes running from the mixing means to the crop field;
(d) a plurality of perforated or porous conduits, running from said supply pipes, on the soil surface or beneath the soil surface in the loci of the roots of the crop plants;
(e) a means for regulating the concentration of crop protection agent in the aqueous mixture and the frequency of application of the crop protection agent.

The method of this invention might thus comprise (i) incorporating the crop protection agent into a water supply to provide an aqueous mixture containing said crop protection agent; (ii) pumping the aqueous mixture through one or more supply pipes to distribute the crop protection agent to a plurality of perforated or porous tubing or irrigation tape on the soil surface or beneath the soil surface in the loci of the roots of the crop plants throughout the crop field; and (iii) regulating the concentration of crop protection agent in the water supply and the frequency of application of the crop protection agent to provide continual crop protection.

The term “aqueous mixture” means a mixture of the crop protection agent in mixture with water (e.g. irrigation water) at a concentration commensurate with the delivery (on a per hectare basis) of effective amounts of the active ingredient. The aqueous mixture may further comprise an agriculturally suitable carrier comprising at least one of a liquid diluent or a surfactant. The phrase “on or near the soil surface” means at the soil surface or within a region extending from a location above the soil surface where the aqueous mixture can be discharged from the conduit and effectively applied to the soil surface to a location below the soil surface where the aqueous mixture can be discharged from the conduit and effectively applied to the plant root zone. This region can vary from crop to crop and according to the growth stage of a particular crop, but generally includes the region extending on average from about 30 cm above the soil surface to about 30 cm below the soil surface. Of note are embodiments where the conduit is located within the region extending on average from the soil surface to 30 cm below the soil surface. Of particular note for potatoes are embodiments where trickle tape is located on average between the soil surface and the top of the planted tuber. The term “growing season” means the period of time from planting of the crop plant (e.g. from seed, tuber, or transplant) until harvest. This period, depending on the crop, may have a duration as long as approximately forty weeks. The term “pest infestation period” means the period of time during a single growing season of the crop when a particular pest propagates or multiplies and infests the crop plant(s). Infestation typically results in damage or yield loss. For example, the infestation period for cyst nematodes lasts from time of planting of the potato to ten weeks after planting.

Added elements may also be incorporated into the control strategy. For example, a closed transfer system may be used for mixing the liquid composition (e.g. a composition comprising oxamyl and/or other active ingredients) with water for delivery to the crop for the control of the stated pests or diseases.

Description of Invertebrate Pests and Foliar Diseases

As referred to in this disclosure, the term “phytophagous invertebrate pest” refers to invertebrate pests causing injury to plants by feeding upon them, such as by eating foliage, stem, leaf, fruit or seed tissue or by sucling the vascular juices of plants. Phytophagous invertebrate pests include various arthropods, gastropods and nematodes of economic importance as pests to plants. The term “arthropod” includes insects, mites, centipedes, millipedes, pill bugs and symphylans. The term “gastropod” includes snails, slugs and other Stylommatophora. The term “nematode” includes the phytophagous nematodes (Phylum or Class Nematoda). Economically important phytophagous invertebrate pests include: larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), tobacco budworm (Heliothis virescens Fabricius)); borers, casebearers, webworms, coneworms, cabbageworms and skeletonizers from the family Pyralidae (e.g., European corn borer (Ostrinia nubilalis Hubner), navel orangeworm (Amyelois transitella Walker), corn root webworm (Crambus caliginosellus Clemens), sod webworm (Herpetogramma licarsisalis Walker)); leafrollers, budworms, seed worms, and fruit worms in the family Tortricidae (e.g., codling moth (Cydia pomonella L. (L. means Linnaeus)), grape berry moth (Endopiza viteana Clemens), oriental fruit moth (Grapholita molesta Busck)); and many other economically important lepidoptera (e.g., diamondback moth (Plutella xylostella L.), pink bollworm (Pectinophora gossypiella Saunders), gypsy moth (Lymantria dispar L.)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), rice weevil (Sitophilus oryzae L.)); flea beetles, cucumber beetles, rootworms, leaf beetles, potato beetles, and leafminers in the family Chrysomelidae (e.g., Colorado potato beetle (Leptinotarsa decemlineata Say), western corn rootworm (Diabrotica virgifera virgifera LeConte)); chafers and other beetles from the family Scaribaeidae (e.g., Japanese beetle (Popillia japonica Newman) and European chafer (Rhizotrogus majalis Razoumowsky)); wireworms from the family Elateridae and bark beetles from the family Scolytidae; adults and larvae of the order Dermaptera including earwigs from the family Forficulidae (e.g., European earwig (Forficula auricularia L.), black earwig (Chelisoches morio Fabricius)); adults and nymphs of the orders Hemiptera and Homoptera such as, plant bugs from the family Miridae, cicadas from the family Cicadidae, leafhoppers (e.g. Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae squash bugs from the family Coreidae, and red bugs and cotton stainers from the family Pyrrhocoridae; adults and larvae of the order Acari (mites) such as spider mites and red mites in the family Tetranychidae (e.g., European red mite (Panonychus ulmi Koch), two spotted spider mite (Tetranychus urticae Koch), McDaniel mite (Tetranychus mcdanieli McGregor)), flat mites in the family Tenuipalpidae (e.g., citrus flat mite (Brevipalpus lewisi McGregor)), rust and bud mites in the family Eriophyidae and other foliar feeding mites; adults and immatures of the order Orthoptera including grasshoppers, locusts and crickets (e.g., migratory grasshoppers (e.g., Melanoplus sanguinipes Fabricius, M. differentialis Thomas), American grasshoppers (e.g., Schistocerca americana Drury), desert locust (Schistocerca gregaria Forskal), migratory locust (Locusta migratoria L.), mole crickets (Gryllotalpa spp.)); adults and immatures of the order Diptera including leafininers, midges, fruit flies (Tephritidae), frit flies (e.g., Oscinella frit L.), soil maggots and other Nematocera; adults and immatures of the order Thysanoptera including onion thrips (Thrips tabaci Lindeman) and other foliar feeding thrips; and centipedes in the order Scutigeromorpha; and members of the Phylum or Class Nematoda including such important agricultural pests as root knot nematodes in the genus Meloidogyne, lesion nematodes in the genus Pratylenchus, stubby root nematodes in the genus Trichodorus, cyst nematodes such as Globodera pallida, Globodera rostochiensis, Paratrichodorus species and Longidorus species.

In a preferred embodiment of this invention, at least one phytophagous invertebrate pest to be controlled is selected from the group consisting of G. pallida, G. rostochiensis, Trichodorus spp., Paratrichodorus spp., Longidorus spp., free-living nematodes, Homopteran species (e.g. Aphids), Coleopteran species (e.g. wireworms and Colorado beetle) and Lepidopteran species (e.g. Potato tuber moth). Especially preferred are methods for controlling at least one pest selected from the group consisting of soil-inhabiting pests G. pallida, G. rostochiensis, Trichodorus spp., Paratrichodorus spp., Longidorus spp. Agriotes spp. Phthorimaea operculella and foliar-inhabiting pests Leptinotarsa decemlineata, Empoasca fabae and Eupterycyba jucunda.

The preferred crop to be protected from phytophagous invertebrate pests is potato. The preferred phytophagous invertebrate pests to be controlled in connection with potato are G. pallida and G. rostochiensis, with control of G. pallida being a problem for which this method is especially useful.

The methods of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops. These pathogens include Plasmopara viticola, Phytophthora infestans, Peronospora tabacina, Pseudoperonospora cubensis, Pythium aphanidermatum, Alternaria solani, Alternaria brassicae, Septoria nodorum, Septoria tritici, Cercosporidium personatum, Cercospora arachidicola, Pseudocercosporella herpotrichoides, Cercospora beticola, Botrytis cinerea, Monilinia fructicola, Pyricularia oryzae, Podosphaera leucotricha, Venturia inaequalis, Erysiphe graminis, Uncinula necatur, Puccinia recondita, Puccinia graminis, Hemileia vastatrix, Puccinia striiformis, Puccinia arachidis, Rhizoctonia solani, Sphaerotheca fuliginea, Fusarium oxysporum, Verticillium dahliae, Pythium aphanidermatum, Phytophthora megasperna, Sclerotinia sclerotiorum, Scierotium rolftsii, Erysiphepolygoni, Pyrenophora teres, Gaeumannomyces graminis, Rynchosporium secalis, Fusarium roseum, Bremia lactucae and other generea and species closely related to these pathogens.

The preferred crop to be protected from diseases caused by fungal plant pathogens is potato. The preferred fungal plant diseases to be controlled on potato are early blight and late blight caused by Alternaria solani and Phytophthora infestans respectively.

Serial Application Strategy

Crop protection agents typically have been applied to the crop (a) prior to or at the time of planting, or (b) during the growing season to the foliar or growing parts of the plant.

Pre-plant applications have included for example, incorporation of the crop protection agent into the soil or treatment of crop seeds. In some instances, a crop protection agent may have been applied to the newly emerged shoots of the crop. In these cases, the crop protection agent has been typically applied as a single one-time dose that must protect the plant for the entire growing season.

Alternatively, some crop protection agents have been applied during the growing season. These applications have been typically made by spraying aqueous suspensions or solutions of crop protection agents onto the foliar parts of the crop plant. In some instances it has been necessary to make repeated applications of a crop protection agent to provide effective season-long protection. However, such applications may not have been completely efficacious because, for example, timely applications may not have been possible due to weather or other factors. Foliar applications also may have been ineffective because of insufficient coverage or distribution of the crop protection agent or poor absorption and translocation of the crop protection agent to parts of the crop plant that were not treated. Application in the later parts of the growing season may also have been impractical because of the size and condition of the crop plant. Because of these factors, it has often been necessary to use greater amounts of crop protection agents to provide effective protection.

As noted above, nematode control has been typically practiced by the use of soil fumigation and/or soil incorporation of granular nematocides. These methods have been typically limited to a single pre-plant application. Application of these methods is ordinarily not feasible during the growing season, because fumigation is often toxic to the crop plant and soil incorporation would often mechanically injure the plant.

Typically, the delivery of the active ingredient into the root locus results in the disorientation of the nematode, preventing root invasion. However, the use of granular nematocides applied by incorporation into the soil at planting may result in insufficient degree of persistence to prevent hatch of later emerging nematodes. This is illustrated in FIG. 1, where Curve 11 represents a relative level of oxamyl in the soil after application (in this Figure, oxamyl is applied by soil incorporation prior to planting of the potato crop). Line 12 represents a critical concentration of oxamyl in the soil sufficient to effectively control the nematode pests. Curve 11 thus shows a decline in oxamyl concentration over time (T) to below the critical concentration. Curve 13 represents a relative population (hatch) of G. rostochiensis over 4-6 weeks and Curve 14 represents a relative population (hatch) of G. pallida over 6-8 weeks. It will be evident that even when oxamyl is applied at a level sufficient to control early-hatching nematodes (i.e. G. rostochiensis) the later-hatching nematodes (i.e., G. pallida) may not be exposed to a sufficiently high concentration of the crop protection agent to be effectively controlled.

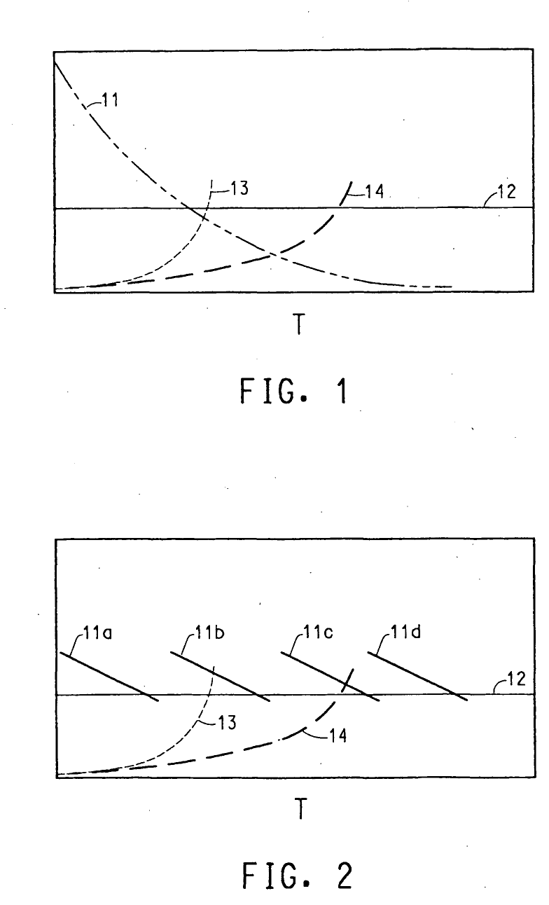

By distribution of the same amount of active material in discrete doses over the hatching period the degree of control is superior to that achieved by a single application at planting. Furthermore, the commencement of treatment can be delayed until roots become active and begin to release the hatching agents. This scheme is illustrated in FIG. 2, where Curves 11a, 11b, 11c, and 11d represent the relative levels of oxamyl in the soil after a series of four applications (applied after planting of the potato crop) and Line 12 represents a critical concentration of oxamyl in the soil sufficient to effectively control the nematode pests. Curves 11a, 11b, 11c and 11d thus show that although oxamyl concentration declines over time (T) for each single dose, concentrations above the critical concentration are renewed by using multiple doses. Curve 13 and Curve 14 represent the relative populations of the nematodes G. rostochiensis and G. pallida, respectively, as described for FIG. 1. It is evident that the serial application of the crop protection agent provides a soil concentration of oxamyl that is sufficient to maintain effective control of even the later-hatching nematodes.

Typically, serial applications of conventional granular crop protection agents are not feasible because the growing plant prevents incorporation of the granular nematicide into the soil. A subsequent foliar application of nematocides is typically not practical because the nematicide is not effectively translocated into the root zone, and thus would require uneconomically high rates of application for effective control.

Introduction of the crop protection agents into the locus of the root zone in accordance with this invention (e.g. by irrigation systems) provides an effective means of delivering serial doses of crop protection agents. The method allows for easy control of the amount of crop protection agent applied and the timing of application. In addition, worker exposure to the crop protection agent can be minimized by using a closed system transfer system.

Of note are embodiments of this invention wherein there are from 2 to 180 applications in the series. Preferred are from 2 to 20 applications, and more preferred are from 3 to 15 applications in the series. Of note are embodiments wherein the initial application in a series for a growing season is made within seven days of planting; and embodiments wherein the initial application in a series for a growing season is made within seven days of the onset of the infestation period of a pest being controlled. Also of note are embodiments wherein applications in the series are spaced apart by at least 2 days (for example, from 4 to 14 days apart). Preferrably, the series includes from 2 to 15 applications during the infestation period of the pest being controlled.

Description of the Crop Protection Agents

Crop protection agents suitable for this method include one or more insecticides, fungicides, nematocides or acaricides. These crop protection agents can also be mixed together with each other or with other agents such as bactericides, growth regulators, chemosterilants, semiochemicals, repellents, attractants, pheromones, feeding stimulants, fertilizers or other biologically active compounds to form a multi-component pesticide giving an even broader spectrum of agricultural protection. Examples of such agricultural protectants are: insecticides such as abamectin, acephate, acetamiprid, avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, fenothicarb, fenoxycarb, fenpropathrin, fenproximate, fenvalerate, fipronil, flucythrinate, tau-fluvalinate, flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, oxamyl, parathion, parathion-methyl, permethrin, phorate, phosalone, phosmet, phosphamidon, pirimicarb, profenofos, pymetrozine, pyriproxyfen, rotenone, spinosad, sulprofos, tebufenozide, teflubenzuron, tefluthrin, terbufos, tetrachlorvinphos, thiacloprid, thiamethoxam, thiodicarb, tralomethrin, trichlorfon and triflumuron; fungicides such as acibenzolar, azoxystrobin, benomyl, blasticidin-S, Bordeaux mixture (tribasic copper sulfate), bromuconazole, carpropamid (KTU 3616), captafol, captan, carbendazim, chloroneb, chlorothalonil, copper oxychloride, copper salts, cymoxanil, cyproconazole, cyprodinil (CGA 219417),(S)-3,5-ichloro-N-(3-chloro-1-ethyl-1-methyl-2-oxopropyl)-4-methylbenzamide (RH 7281), diclocymet (S-2900), diclomezine, dicloran, difenoconazole,(S)-3,5-dihydro-5-methyl-2-(methylthio)-5-phenyl-3-(phenylamino)₄H-imidazol-4-one (RP 407213), dimethomorph, diniconazole, diniconazole-M, dodine, edifenphos, epoxiconazole (BAS 480F), famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), myclobutanil, neo-asozin (ferric methanearsonate), oxadixyl, penconazole, pencycuron, probenazole, prochloraz, propamocarb, propiconazole, pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis including ssp. aizawai and kurstaki, Bacillus thuringiensis delta endotoxin, baculovirus, and entomopathogenic bacteria, virus and fungi.

Preferred invertebrate pest control agents include oxamyl, aldicarb, ethoprophos, fenamiphos and fosthiesate, with oxamyl especially preferred.

Preferred fungicidal plant protection agents include cymoxanil, famoxadone, fenamidone, oxadixyl and metalaxyl.

Active ingredients used in accordance with the methods of this invention may optionally be used as a formulation or composition with an agriculturally suitable carrier comprising at least one of a liquid diluent or a surfactant that is further diluted with water. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like. Useful formulations further include solids such as dusts, powders, granules, pellets, tablets, films, and the like that are water-soluble.

The formulations will typically contain effective amounts of active ingredient, diluent and surfactant within the following approximate ranges that add up to 100 percent by weight.

| | Weight Percent | | |
|---|---|---|---|
| | Active | | |
| | Ingredient | Diluent | Surfactant |
| Water-soluble Granules, Tablets and | 5-90 | 0-94 | 1-15 |
| Powders. | | | |
| Suspensions, Emulsions, Solutions | 5-50 | 40-95 | 0-15 |
| (including Emulsifiable | | | |
| Concentrates) | | | |

Typical liquid diluents are described in Marsden, Solvents Guide, 2nd Ed., Interscience, New York, 1950. McCutcheon 's Detergents and Emulsifiers Annual, Allured Publ. Corp., Ridgewood, N. J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxy-ethylene/polyoxypropylene block copolymers. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol, benzyl and tetrahydrofurfuryl alcohol.

Solutions, including emulsifiable concentrates, can be prepared by simply mixing the ingredients. Granules and pellets can be prepared by spraying the active material upon preformed granular carriers or by agglomeration techniques. See Browning, “Agglomeration”, Chemical Engineering, Dec. 4, 1967, pp 147-8, Perry's Chemical Engineer's Handbook, 4th Ed., McGraw-Hill, New York, 1963, pages 8-57 and following, and PCT Publication WO 91/13546. Pellets can be prepared as described in U.S. Pat. No. 4,172,714. Water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

A typical composition for the principle embodiment is a liquid formulation comprising a variable percentage of oxamyl active ingredient. The solubility of oxamyl in water and subsequent dispersion in soil makes it an ideal candidate for utilization in this method. A particularly useful composition for this method is a liquid concentrate formulation comprising 10% oxamyl as active ingredient, as described below. This liquid concentrate is further diluted with water and delivered to the crop field by an irrigation system (e.g. the system described below).

Composition A

| | | Concentration | |
|---|---|---|---|
| Ingredients | CAS # | (% wt) | Purpose |
| Oxamyl, pure | 23135-22-0 | 10.00 | Active Ingredient |
| Oxamyl technical | various | 1.00 | Technical Impurities |
| impurities | | | |
| Citric acid | 77-92-9 | 1.00 | Buffer |
| FD&C Yellow #5 | 1934-21-0 | 0.03 | Dye |
| FD&C Blue #1 | 3844-45-9 | 0.02 | Dye |
| Sucrose Octaacetate | 126-14-7 | 0.10 | Embittering Agent |
| (SOA) | | | |
| Water | 7732-18-5 | 87.85 | Diluent |

This product is prepared by diluting a 60% oxamyl-in-water mixture (prepared during the manufacture of “oxamyl technical product”) by water and adding citric acid and dyes (and also SOA, as needed).

Using an Irrigation System

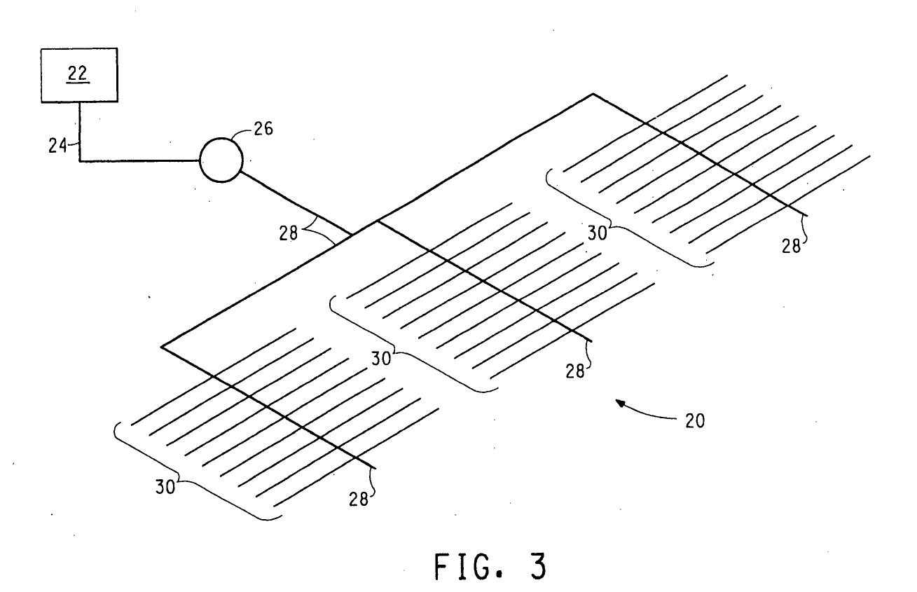

It will be evident that the size of the perforations and/or pores in the conduit used for applying the crop protection agent should be sized so that the crop protection agent can effectively emanate from the conduit. The ability to deliver the required serial dose may be practically effected by utilizing an irrigation system already in use by some growers to supply water to developing crops. Preferrably, perforated or porous tubing is positioned above the planted tuber at planting, with positioning below the surface of the soil being especially desirable. Trickle tape (e.g. T-tape) is particularly effective tubing for delivery of the active ingredient to the locus of the root of the crop plant. The tape is designed to emit water and the outlets are designed so that the probability of blockages is low. Conventional equipment may be used to place the tape in the ridge as the crop is planted. The trickle tape may then be connected to the main supply pipe(s) fed by a pump (filters may be used as appropriate). A transfer system for introduction of the active ingredient into the water flowing to the crop may be positioned either upstream or downstream of the pump. The introduction may be carried out, for example, via a Venturi system (see below). FIG. 3 illustrates the basic elements of a typical operating system (20) comprising a water source (22), pump supply pipe (24), a pump unit (26), field supply pipes (28) and perforated or porous conduits (30). Trickle tape, equipment for its placement in the ridge, and other irrigation system components are available from various irrigation supply houses (e.g. Field Irrigation, Asparagus Farm, Court Lodge Road, Appledore, Kent, TN26 2DH, UK).

Description of A Closed System Transfer System

The method of this invention may employ a closed system transfer system for mixing a liquid concentrate (e.g., a suspension, emulsion or solution) of a crop protection agent with water prior to delivery to the locus to be treated. In a preferred embodiment the means of incorporating the crop protection agent comprises a venturi injection apparatus. In another preferred embodiment, the means of incorporating the crop protection agent comprises a computer-controlled metering system.

A suitable closed system transfer injection apparatus is illustrated in FIG. 4. The apparatus (40) comprises a product container (42) connected to an injection tank (44) via a transfer tube (46). The transfer tube is designed to provide flow of active ingredient from the product container (42) to the injection tank (44) without release of the active ingredient to the outside environment. A transfer valve (not shown) may be included within the transfer tube (46) to control the flow of active ingredient. The apparatus (40) further comprises a discharge tube (48) suitable for connection to a device (e.g. the venturi apparatus described below) for mixing the active ingredient with irrigation water prior to delivery to the field irrigation system. A flow meter (50) and a ball valve (52) are positioned along the length of the tube (48) to control flow of the active ingredient from the injection tank (44). Quick connect (54) and quick connect (56) are provided as hose connections to allow for rinsing the product container (42) and the injection tank (44) respectively with water. The quick connect (56) for rinsing the injection tank (44) is connected to a tank rinse nozzle (58) centrally positioned within the injection tank (44) to facilitate rinsing of the entire interior of the tank. Water introduced through the quick connects, especially quick connect (54) can be used to reduce the concentration of active ingredient relative to that in the product container (42). The sidewall (59) of the injection tank (44) may be made of transparent material to allow for observation of its contents (including the tank rinse nozzle (58)).

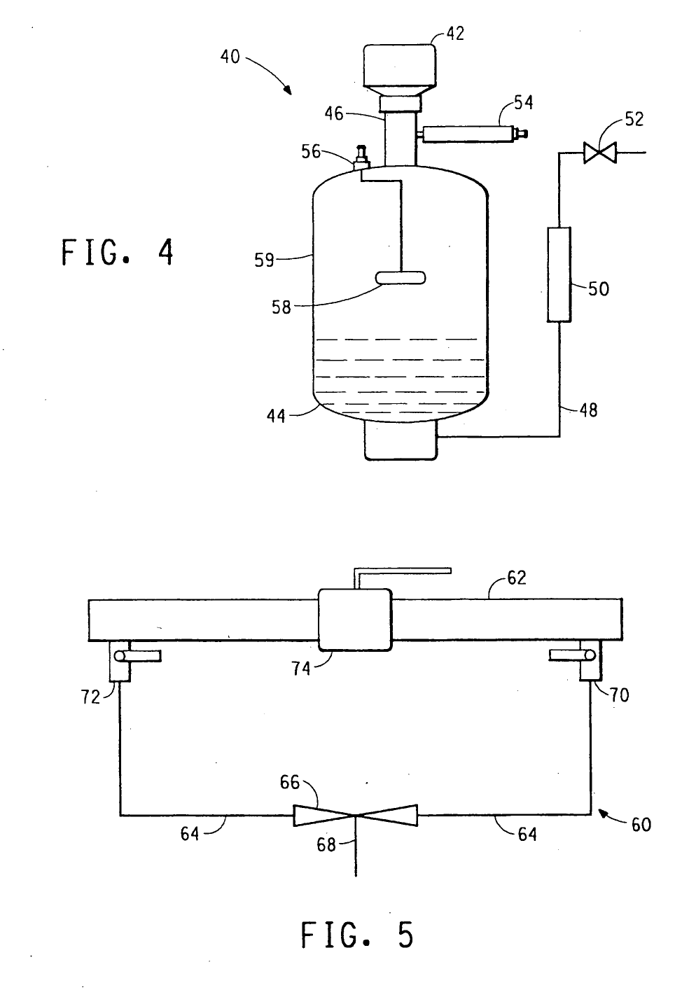

FIG. 5 illustrates a venturi apparatus (60) that may be used in connection with the method of this invention (e.g., with the closed system injection apparatus (40) described above). In the venturi apparatus (60) shown, a pipe (62) for delivering water from a water source to a crop field for irrigation is connected to a venturi pipe (64). A Venturi device (66) is positioned along the Venturi pipe (64) and is connected to an injection tube (68) positioned at the throat of the Venturi (66). The injection tube (68) is designed for connection to a source of active ingredient (e.g. the discharge tube (48) of the apparatus illustrated in FIG. 4) to allow for injection of active ingredient into the water passing through the pipe (64). Ball valve (70) and ball valve (72) are positioned along the Venturi pipe (64) at its upstream and downstream connections to the pipe (62), respectively, and a flow control valve (74) is positioned along pipe (62) between its upstream and downstream connections to the Venturi pipe (64). The valves (70), (72) and (74) can be used to control both the overall flow of water through the pipes (62) and (64) and the relative flow of water between pipe (62) and pipe (64).

The advantages of this particular system include the low potential for both operator exposure and accidental contamination of the water source.

### BIOLOGICAL EXAMPLES OF THE INVENTION TEST A

### Control of G. pallida by oxamyl

G. pallida is the more pernicious pest of potatoes. Studies have been conducted with Composition A comprising oxamyl as described above.

The test units consisted of large diameter pots each containing one potato plant, planted in soil amended with eggs of G. pallida at either 24 cysts per pot (estimated to be about 10 eggs/g of soil) or 120 cysts per pot (estimated to be about 50 eggs/g of soil). These pest burdens represent a level of infestation that would require treatment in order to prevent crop damage and potential multiplication of the pest (10 eggs/g of soil) and substantial yield loss (50 eggs/g of soil).

Composition A was introduced into the test units diluted in a constant volume of water. Applications of total active ingredient (ai) of oxamyl at rates of 3.5 kg ai, 4.5 kg ai or 5.5 kg ai equivalent per hectare were made either as a single dose (full dose applied at the start of the experiment (3.5 kg/ha ai, 4.5 kg/ha ai or 5.5 kg/ha ai) or a series of aliqots at intervals of either 4-day, 7-day or 14-day intervals. The serial aliquot applications were made as follows to the infested soils: one fourteenth of the dose applied at the start of the experiment and repeated every 4 days (fourteen treatments) for each of the doses defined above; one eighth of the dose applied at the start of the experiment and repeated every 7 days (eight treatments) for each of the doses defined above; one fourth of the dose applied at the start of the experiment and repeated every 14 days (four treatments) for each of the doses defined above. The dose at each application was applied in the same volume of water and in equal incremental quantities. Control experiments were left untreated. The number of cysts attached to the roots per gram of root mass (washed free of soil) was determined at 70 days (10 weeks) after commencement of the trial. This measurement indicates that the degree of control and the duration of the applications adequately covered the potentially extended hatching period of G. pallida. The tests were replicated four times and the results are reported as the average of the four replicates.

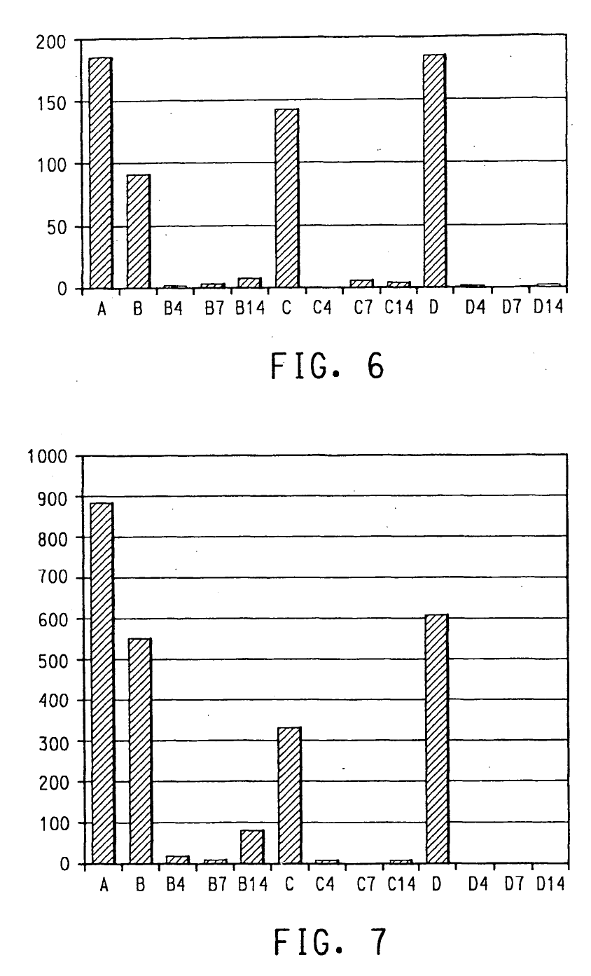

The results for the initial infestation of 10 eggs per gram of soil (from 24 cysts per pot) are shown in FIG. 6, and the results for an initial infestation of 50 eggs per gram of soil (from 120 cysts per pot) are shown in FIG. 7. FIGS. 6 and 7 each show, for the respective initial infestation, the number of cysts per gram of root mass after 70 days for various treatment alternatives. The runs illustrated in FIG. 6 and FIG. 7 include an untreated control (run A), a single treatment of 3.5 kg/ha at the beginning of the 70 days (at planting) (run B), a treatment totaling 3.5 kg/ha allocated over a series of 14 applications spaced in 4 day intervals (run B4), a treatment totaling 3.5 kg/ha allocated over a series of 8 applications spaced in 7 day intervals (run B7), a treatment totaling 3.5 kg/ha allocated over a series of 4 applications spaced in 14 day intervals (run B14), a single treatment of 4.5 kg/ha at the beginning of the 70 days (at planting) (run C), a treatment totaling 4.5 kg/ha allocated over a series of 14 applications spaced in 4 day intervals (run C4), a treatment totaling 4.5 kg/ha allocated over a series of 8 applications spaced in 7 day intervals (run C7), a treatment totaling 4.5 kg/ha allocated over a series of 4 applications spaced in 14 day intervals (run C14), a single treatment of 5.5 kg/ha at the beginning of the 70 days (at planting) (run D), a treatment totaling 5.5 kg/ha allocated over a series of 14 applications spaced in 4 day intervals (run D4), a treatment totaling 5.5 kg/ha allocated over a series of 8 applications spaced in 7 day intervals (run D7), and a treatment totaling 5.5 kg/ha allocated over a series of 4 applications spaced in 14 day intervals (run D14).

The data indicate that superior control of cyst production by G. pallida can be achieved by distributing serial small of doses of active ingredient on a temporal basis at either 4-day, 7-day or 14-day intervals, over the hatching period, compared to the equivalent dose applied at planting in one application irrespective of the initial pest burden.

1. A method of protecting crop plants by controlling phytophagous invertebrate pests, plant diseases caused by fungal pests, or both, comprising:
applying a series of doses of an aqueous mixture containing an effective amount of a crop protection agent to the locus of the roots of the crop plants by means of perforated or porous conduit on or near the surface of the soil; at least one dose of said series being applied in the period from one week prior to planting to two days prior to harvest; and at least two doses of said series being applied at least two days apart during the growing season of the crop or the infestation period of a pest being controlled.

2. The method of claim 1 wherein a soil-inhabiting invertebrate pest is controlled by applying an effective amount of the aqueous mixture containing a crop protection agent to the soil at the locus of the roots of the crop plant.

3. The method of claim 2 wherein potatoes are protected from at least one pest selected from the group consisting of G. pallida, G. rostochiensis, Trichodorus spp., Paratrichodorus spp., Longidorus spp. Agriotes spp. and Phthorimaea operculella.

4. The method of claim 3 wherein potatoes are protected from G. pallida.

5. The method of claim 4 wherein the crop protection agent is selected from the group consisting of oxamyl, aldicarb, ethoprophos, fenamiphos and fosthiesate.

6. The method of claim 5 wherein the crop protection agent is oxamyl.

7. The method of claim 6 wherein the crop protection agent is applied in a series of from 4 to 14 applications.

8. The method of claim 7 wherein the initial application in the series for a growing season is made within seven days of planting.

9. The method of claim 1 wherein a fungal disease caused by a soil-inhabiting fungal pathogen is controlled by applying an effective amount of the aqueous mixture containing a crop protection agent to the soil at the locus of the roots of the crop plant.

10. The method of claim 1 wherein a foliar-inhabiting invertebrate pest is controlled by applying to the soil at the locus of the roots of a crop plant an effective amount of the aqueous mixture containing a crop protection agent which is then taken up by the plant from the soil.

11. The method of claim 10 wherein potatoes are protected from at least one pest selected from the group consisting of Leptinotarsa decemlineata, Empoasca fabae and Eupterycyba jucunda.

12. The method of claim 1 wherein a fungal disease caused by a foliar-inhabiting fungal pathogen is controlled by applying to the soil at the locus of the roots of a crop plant an effective amount of the aqueous mixture containing a crop protection agent which is then taken up by the plant from the soil.

13. The method of claim 12 wherein potatoes are protected from at least one fungal disease caused by a fungal pathogen selected from the group consisting of Phytophthora infestans and Alternaria solani.

14. The method of claim 1 wherein the initial application in the series for a growing season is made within seven days of the onset of the infestation period of a pest being controlled.
